(19) United States
(12) Patent Application Publication
(10) Pub. No.: US 2025/0358762 A1
(43) Pub. Date: Nov. 20, 2025

(54) SELECTION OF NETWORKS FOR SERVICE BY USER EQUIPMENT

(71) Applicant: Nokia Technologies Oy, Espoo (FI)

(72) Inventors: Karim MORSY, Munich (DE); Sung Hwan WON, Dallas, TX (US)

(21) Appl. No.: 19/193,097

(22) Filed: Apr. 29, 2025

(30) Foreign Application Priority Data
May 20, 2024 (GB) 2407136.7

(51) Int. Cl. H04W 60/00; H04W 48/18

(52) U.S. Cl. CPC H04W 60/00; H04W 48/18

(57) ABSTRACT

A user equipment (UE) having a usage setting set to voice centric that is configured to perform: sending a request to register the UE with a network associated with an access technology comprising one of terrestrial radio access network (RAN) and satellite-based RAN, receiving a response to the request and, based on information in the response, determining that a voice service of the network is not available; storing an identification of the network in association with an indication of the access technology associated with the network for which voice service of the network is not available, in information identifying networks with associated access technologies for which the voice service is not available; and selecting a candidate network for sending a further request to register the user equipment, the candidate network with associated access technology other than the networks with associated access technologies identified in the information stored.

### CROSS-REFERENCE TO RELATED APPLICATIONS

This patent application claims the benefit of priority of United Kingdom Patent Application No. 2407136.7, filed on May 20, 2024, which is hereby incorporated by reference.

### FIELD OF TECHNOLOGY

The present disclosure relates to selection of networks that support voices services based on a determination by a user equipment set to “voice centric”, that a voice service is not available.

### BACKGROUND

When a user equipment (UE) that has a usage setting set to “voice centric” registers with a communication network, the UE sends a registration request to initiate registration with a core network of the communication network associated with an access technology and receives a response to the registration request. In the response to the registration request, there is an indication of whether voice service over a packet switching (PS) session is supported or not supported and, in an instance that the response includes an indication that a voice service over PS session is not supported, the UE then attempts to select another communication network or the same communication network associated with a different access technology and attempts to register with the another communication network or the same communication network associated with a different access technology which possibly supports voice service over PS session because attempting to register with the same communication network associated with the same access technology again will result in the same determination that voice service over PS session is not supported, thus utilizing network resources without resulting in the UE registering with a communication network that supports voice service over PS session.

Improvements in selecting communication networks by a user equipment comprising a usage setting set to “voice centric” are desirable.

### SUMMARY

According to a first aspect of an embodiment, a method of a user equipment (UE) having a usage setting set to voice centric, includes sending a request to register the UE with a network associated with an access technology comprising one of terrestrial radio access network (RAN) and satellite-based RAN, receiving a response to the request, the response comprising information indicating that a voice service of the network is not available, based on the response comprising information indicating that a voice service of the network is not available, storing an identification of the network in association with an indication of the access technology associated with the network for which voice service of the network is not available, in information identifying networks with associated access technologies for which the voice service is not available, and selecting, as a candidate network for sending a further request to register the user equipment, the candidate network with associated access technology other than the networks with associated access technologies identified in the information stored.

In a first example of the first aspect, selecting comprises excluding selection of the networks with the associated access technologies identified in the information stored unless no other network and associated access technology is available that is not identified in the information.

In a second example, storing the identification of the network in association with the indication of the access technology associated with the network for which the voice service is not available may comprise storing, in information associated with the access technology, the identification of the network.

In the third example, the method of the second example also includes sending a further request to the network associated with another access technology comprising another one of the terrestrial RAN and satellite-based RAN, and receiving a further response to the request and, based on the further response, determining that the voice service is not available for the other access technology associated with the network.

In a fourth example, the method of the third example further includes storing, in second information associated with the other access technology, the identification of the network, and selecting, as another candidate for sending another request to, another network and associated access technology other than the networks with associated access technologies identified in any of the information stored and the second information stored.

In a fifth example, the method of the third example, further includes storing, in association with the identification of the network stored in the information, an indicator associated with both the access technology and the other access technology.

In a sixth example of the first aspect of the embodiment, the method includes storing the identification of the network in association with the indication of the access technology associated with the network for which voice service of the network is not available, comprises storing, in the information, the identification of the network along with an indicator of the access technology.

In a seventh example, the method of the sixth example, includes sending a further request to the network associated with another access technology comprising another one of the terrestrial RAN and satellite-based RAN, and receiving a further response to the further request and, based on the response, determining that the voice service is not available for the other access technology associated with the network.

In an eight example, the method of the seventh example includes storing, in the information, another indicator of the other access technology in association with the identification of the network in the information.

In an ninth example, the method of the seventh example includes storing a further entry in the information, the further entry including the identification of the network along with a further indicator of the other access technology associated with the network.

In a tenth example, the method of the seventh example includes removing the indicator of the access technology associated with the network for which voice service of the network is not available such that the identification of the network is stored absent the indicator in the information.

In an eleventh example, the network for which the identification is stored absent the indicator in the information in the tenth example, is excluded as selection as another candidate for sending another request to unless no alternative network or alternative network and associated access technology that is not identified in the information stored, is available.

In a twelfth example, the method of the seventh example includes changing the indicator of the access technology stored in association with the identification of the network in the information, to a second indicator of both the access technology and the other access technology.

In a thirteenth example, the method of any of the above aspect of the embodiment and example thereof includes starting a timer associated with the identification of the network in association with the indication of the access technology associated with the network for which voice service of the network is not available, after receiving the response.

In a thirteenth example, receiving the response to the request the method of any of the above aspect of embodiment and example thereof includes receiving a registration accept, indicating that voice service is not available for the access technology.

According to a second aspect of an embodiment, a method of a user equipment (UE) having a usage setting set to voice centric, includes sending a registration request to a network associated with an access technology comprising one of terrestrial next generation radio access network (NG-RAN) and satellite-based NG-RAN, receiving a response to the request and, based on the response, determining that internet protocol multimedia system (IMS) voice over packet switching (PS) session is not available in N1 mode, storing an identification of the network in association with an indication of the access technology for which IMS voice over PS session is not available in N1 mode, in information identifying networks with associated access technologies for which IMS voice over PS session is not available in N1 mode, and selecting, as a candidate network for sending a further registration request to, a further network and associated access technology, other than the networks with associated access technologies identified in the information stored.

According to a third aspect of an embodiment, a method of a user equipment (UE) having a usage setting set to voice centric, includes sending a registration request to a network associated with an access technology comprising one of terrestrial next generation radio access network (NG-RAN) and satellite-based NG-RAN, receiving a response to the request and, based on the response, determining that internet protocol multimedia system (IMS) voice over packet switching (PS) session is not available in N1 mode for the access technology associated with the network, storing an identification of the network in first information including identifications of networks, which first information is associated with the access technology comprising the one of the terrestrial NG-RAN and the satellite NG-RAN, and selecting, as a candidate network for sending a further registration request to, a further network and associated access technology, other than the networks associated with the access technology identified in the first information stored.

According to a fourth aspect of an embodiment, a user equipment includes at least one processor, and at least one memory storing instructions, wherein the instructions are executable by the at least one processor to cause the user equipment to perform the method according to any of the above aspects and examples.

According to a fifth aspect of an embodiment, a non-transitory computer-readable medium includes instructions stored thereon for execution by at least one processor of a user equipment (UE) to cause the UE to perform the method according to any one of the examples and the first through the third aspects.

According to a sixth aspect, a computer program includes instructions that, when executed by at least one processor of a user equipment (UE) causes the UE to perform the method according any one of the examples and the first through the third aspects.

### BRIEF DESCRIPTION OF THE DRAWINGS

Embodiments of the present disclosure will now be described, by way of example only, with reference to the attached figures.

FIG. 1 is a schematic diagram showing a communication network in accordance with an aspect of an embodiment.

FIG. 2 is a schematic diagram showing a user equipment (UE) in accordance with an aspect of an embodiment.

FIG. 3 is a flowchart illustrating a method in accordance with an example of an embodiment.

FIG. 4 through FIG. 8 are flow charts illustrating examples of processes of the method of FIG. 3.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The present disclosure relates to selection of a network by a user equipment (UE) having a usage setting set to voice centric. The UE sends a request to register with a communication network (e.g., a public land mobile network) associated with an access technology. The request to register with a communication network may be an attach request or a tracking area update request when the communication network is associated with EUTRAN or satellite EUTRAN. The request to register with a communication network may be a registration request when the PLMN is associated with NG-RAN and satellite NG-RAN. The access technology is one of terrestrial radio access network (RAN) and satellite-based RAN. A response to the request is received and the UE determines, based on information in the response, that a voice service of the communication network is not available (e.g., IMS voice over PS session is not available). The UE stores an identification of the communication network in association with an indication of the access technology associated with the communication network for which voice service of the network is not available (e.g., for which IMS voice over PS session is not available), in information identifying communication networks with associated access technologies for which the voice service is not available (e.g., for which IMS voice over PS session is not available). The UE selects as a candidate network for sending a further request to, a further network with associated access technology other than the networks with associated access technologies identified in the information stored.

The voice centric setting is a usage setting of the user equipment indicating that a voice service is prioritized over a data service. Smartphones, for example, are generally have a usage setting that is set to voice centric while tablets or dongles, for example, have a usage setting that is set to data centric. The UE prioritizes registration with a communication network through which voice service, (e.g., for which IMS voice over PS session is not available), is available for user equipment with a usage setting set to voice centric. IMS voice service refers to voice call service provided by IMS of the network. An example of IMS voice service is VOLTE, in which a voice service is provided by an IMS of a data network via an Evolved Universal Mobile Telecommunications System Radio Access Network (E-UTRAN) and an Evolved Packet Core (EPC).

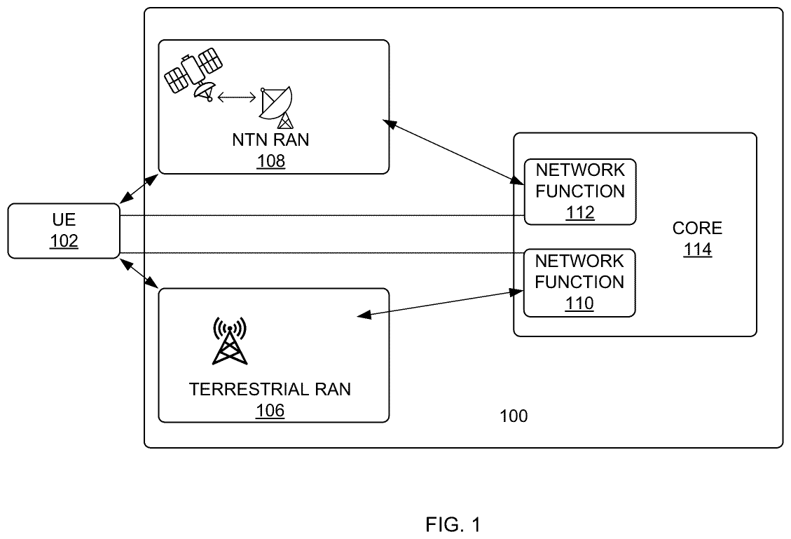

Reference is first made to FIG. 1, which shows a schematic representation of a communication network 100 that is configured to enable communication by a user equipment (UE) 102 through the communication network 100.

The communication network 100 includes a terrestrial radio access network (RAN) 106, such as a 5G-RAN otherwise referred to as a next generation (NG)-RAN. The terrestrial RAN 106 includes one or more radio access network (RAN) nodes, or base stations that are located on the ground or a physical structure on the ground. Such base stations include, for example, gNodeBs (gNBs). The RAN 106 is connected to the core network 114 by a network function 110, such as an access and mobility function (AMF), to facilitate communication between the UE 102 and other network functions of the core network 114.

The communication network 100 also includes a non-terrestrial radio access network (NTN RAN) 108, also referred to as a satellite RAN or satellite-based RAN, such as a 5G-satellite RAN otherwise referred to as a satellite next generation (NG)-RAN. The NTN RAN 108 includes one or more satellites, that are located in space, in orbit around the earth. The satellites are operable to communicate with one or more non-terrestrial network (NTN) gateways on the ground or on a structure located on the ground. The NTN gateways provide a communication connection to the core network 114 by a network function 112, such as an access and mobility function (AMF), to facilitate communication between the UE 102 and other network functions of the core network 114.

Thus, the communication network 100 includes the core network 114, the terrestrial RAN 106, also referred to as the RAN, and the non-terrestrial RAN (NTN RAN), also referred to as satellite RAN. The UE 102 communicates with the core network 114 via either the RAN or the NTN RAN. Thus, a connection between the UE 102 and the core network 114 is established either via the RAN 106 and the network function 110 or between the UE 102 and the core network 114 via the NTN RAN 108 and the network function 112. The NTN RAN provides an alternative communication path between the UE 102 and the core network 114.

In the example shown in FIG. 1, two network functions, i.e., network function 110 and network function 112, are shown. Rather than connecting to respective network functions as illustrated, the terrestrial RAN 106 and the NTN RAN 108 may both connect to the same network function, such as an AMF in the example of 5G.

In one example, the core network 114 is a 5G core network (5GC), that operates based on the 5th generation radio access technology described in the 3rd Generation Partnership Project (3GPP) standard for new radio, which is referred to generally as the “3GPP 5G standard”. In the example in which the core network 114 is a 5GC, the terrestrial RAN 106 is an NG-RAN that has a control plane connection to the network function 110, which is an access and mobility function (AMF) of the 5GC. The connection of the UE 102 to the network function 110 (e.g., AMF) via the NG RAN, which is referred to as the terrestrial RAN, is referred to as the N1 interface and control plane signaling between the UE 102 and the network function 110 goes this connection. The UE 102 may operate in an N1 mode which is a mode of the UE 102 that allows the UE 102 to access the 5GC via the NG RAN.

In this example in which the core network 114 is a 5GC, the NTN RAN 108 is a satellite NG-RAN that connects to the network function, which is also an AMF 112 of the 5GC. The direct connection of the UE 102 to the AMF 112 via the satellite NG RAN, is also referred to as an N1 interface and communication or operation through this connection is referred to as N1 mode.

The core network 114 has a service-based architecture and comprises a plurality of network functions, including control plane network functions (NFs) and user plane network functions. The control plane network functions include the access and mobility functions AMF 110 and AMF 112 as well as several other functions such as a trusted application function (AF), an authentication server function (AUSF), a binding support function (BSF), a network exposure function (NEF), a network slicing selection function (NSSF), a policy control function (PCF), a session management function (SMF), a unified data repository (UDR), a united data repository (UDM), a charging function (CHF), a network repository function (NRF), and a network data analytics function (NWDAF). The user plane network functions include the user plane function (UDF).

The functionalities of the network functions of the core network are well known to a person skilled in the art and hence are not shown or described in detail herein.

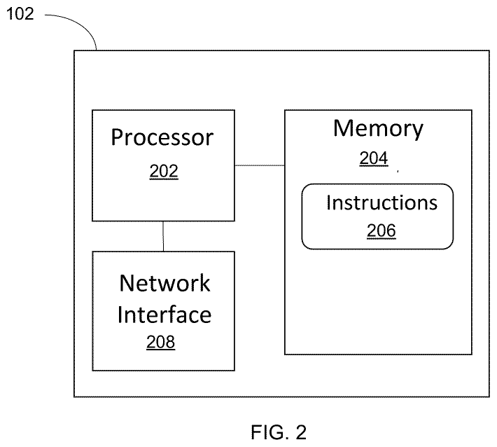

Referring to FIG. 2, a schematic diagram illustrating physical and logical components of an example of a UE 102 is shown. Although physical and logical components of the UE 102 are shown and discussed below, other physical components and other logical components are also included. In addition, although FIG. 2 shows a single instance of each component of the UE 102, there may be more than one instance of each component shown. The components of the UE 102 communicate via a bus.

The UE 102 includes one or more processors 202, such as a central processing unit (CPU), a microprocessor, an application-specific integrated circuit (ASIC), a field-programmable gate array (FPGA), a dedicated logic circuitry, a graphics processing unit (GPU), a tensor processing unit, a neural processing unit, a dedicated artificial intelligence processing unit, a hardware accelerator, or combinations thereof. The one or more processors 202 are collectively referred to as a processor 202.

The UE 102 also includes one or more memories 204 (collectively referred to as “memory 204”), including one or more volatile or non-volatile memory (e.g., a flash memory, a random-access memory (RAM), and/or a read-only memory (ROM)). The non-transitory memory 204 stores instructions for execution by the processor 202. Instructions 206 of the UE 102 are stored in the memory 204, and the instructions 206 are executed by the processor 202 to perform the actions or operations of the methods or processes described herein. The memory 204 also includes other instructions for execution by the processor 202. The memory 204 is also utilized for data or information storage, retrieval and caching functions of the UE 102.

The UE 102 includes one or more network interfaces 208 for connecting to a network, such as the network 100 (shown in FIG. 1).

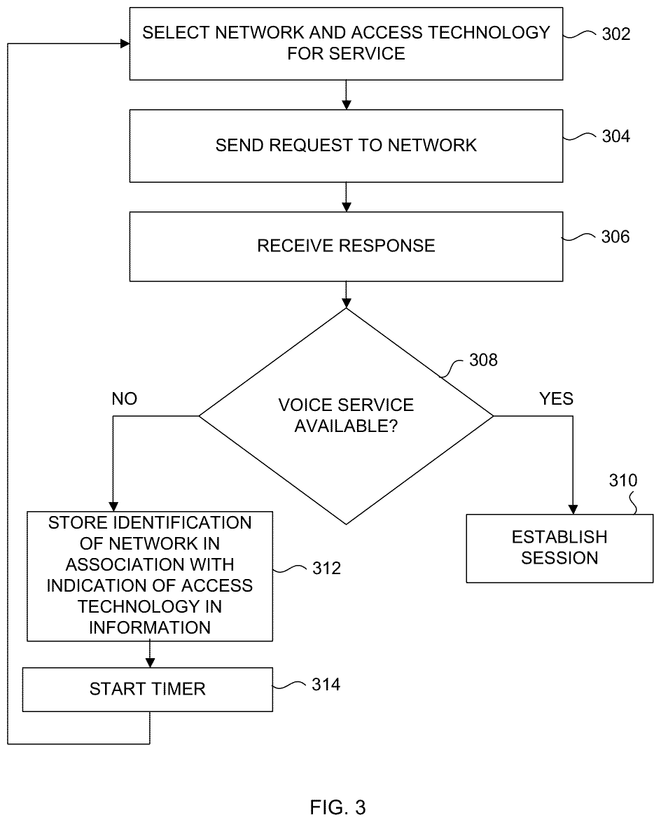

Referring now to FIG. 3, a flow chart showing an example method or process of a UE, such as the UE 102, is shown. The example method or process is performed by the UE in communication with the communication network 100. The UE has a usage setting set to voice centric.

At 302, the UE, such as the UE 102, which has the usage setting set to voice centric, selects as a candidate network, an available network and access technology comprising terrestrial RAN and satellite-based RAN, for voice services at 302. In selecting an available network and access technology for voice services, the UE identifies radio access networks of the available network that are available, i.e., radio access networks that the UE is able to communicate with. The radio access networks that the UE is able to communicate with may include terrestrial RAN nodes and non-terrestrial RAN nodes (i.e., satellite nodes).

Of the RANs of the available network or networks, the UE identifies a network and associated access technology that is not included in information stored on the UE, identifying networks and associated access technologies for which voice service was not previously available or supported. Thus, the UE selects as a candidate network for sending a registration request to, a network associated access technology other than a network with associated access technology identified in the information stored.

The networks with the associated access technologies identified in the information stored are excluded from selection unless no other network with associated access technology is available that is not identified in the information.

The UE sends a request to the network at 304. The request is utilized by the UE to initiate the registration process with the core network. The request is registration request in the example of a 5G network (also referred to as a 5GS). Alternatively, the request is an attach request in the example of an Evolved Packet System (EPS), also referred to as a 4G network. The request is sent to the candidate network and associated access technology. The request is therefore sent via terrestrial RAN or NTN RAN to a core network (e.g., an MME of EPS when the request is an attach request or an AMF of the 5G core network when the request is a registration request). Thus, the UE sends the request to a network (e.g., a 4G network or a 5G network) associated with access technology, which may be terrestrial RAN or NTN RAN identified at 302.

A response to the request is received at 306. The response is received after authentication and security processes are completed at the core network. The response is a Registration Accept message in the example of the 5G network or an Attach Accept message in the example of the 4G network (EPS). The response includes information that indicates voice service is available or not available. In some examples, the information that indicates voice service is available or not available may be a flag which when set indicates that voice service is available and when not set indicates that voice service is not available. In some examples, the information that indicates voice service is available or not available may be a bit having a value of 0 to indicate that voice service is available and a value of 1 to indicate that voice service is not available (or vice versa).

At 308, the UE determines, based on information included in the response received at 306, and the candidate network with access technology selected at 302 and from which the response is received at 306, if voice service is available. In the example of the 5GC network, the UE determines, based on the information included in the response received at 306, and the candidate network with access technology selected at 302 and from which the response is received at 306, if IP multimedia subsystem (IMS) voice over PS session is available.

Based on a determination by the UE at 308 that the voice service is available utilizing the candidate network with the access technology selected at 302, the UE requests at 310 establishment of a PS session at 310 for voice services (e.g., the UE sends, to the core network 114, a request for of a PS session at 310 for voice services).

Based on a determination by the UE at 308 that the voice service is not available utilizing the candidate network with the access service selected at 302, the process continues at 312.

At 312, an identification of the network in association with an indication of the access technology for which voice service is not available, is stored in the information on the UE, identifying networks and associated access technologies for which voice service was not previously available or supported.

A timer is started at 314. The timer is associated with the identification of the network in association with the indication of the access technology stored in the information at the UE. The identification of the network in association with the indication of the access technology is removed from the information after the timer ends.

The process continues at 302 and a further candidate network with associated access technology is identified, other than the networks with associated access technologies identified in the information stored.

Thus, in the case in which a network with associated access technology is identified in the information at 312, the UE selects a different network and associated access technology as a candidate network at 302. The same network may be selected with a different access technology, for example. Thus, in the example in which a network is identified in association with terrestrial RAN in the information stored on the UE, the same network, but associated with NTN RAN may be selected as a candidate network at 302. Similarly, in the example in which a network is identified in association with NTN RAN in the information stored on the UE, the same network, but associated with terrestrial RAN may be selected as a candidate network at 302. Alternatively, another network with a different core network may be identified.

The networks with the associated access technologies identified in the information are excluded from selection unless no other network with associated access technology is available that is not identified in the information.

In the example of the 5G network, the UE, which has the usage setting set to voice centric, selects an available network and access technology at 302 for sending a registration request to.

The UE sends the registration request to the network at 304 via the selected one of the terrestrial NG-RAN or NTN NG-RAN identified at 302.

A registration accept message is received at 306 and the registration accept message includes information that indicates whether internet protocol multimedia system (IMS) voice over packet switching (PS) session is available or not available. In some examples, the information that indicates voice service is available or not available may be a flag which when set indicates that voice service is available and when not set indicates that voice service is not available. In some examples, the information that indicates voice service is available or not available may be a bit having a value of 0 to indicate that voice service is available and a value of 1 to indicate that voice service is not available (or vice versa).

At 308, the UE determines, based on the information included in registration accept message received at 306 and the candidate network with access technology selected at 302 and from which the response is received at 306, that internet protocol multimedia system (IMS) voice over packet switching (PS) session is available utilizing the network with associated access technology selected.

Based on a determination by the UE, that the IMS voice over PS session is available utilizing the candidate network with the access service selected at 302, the UE requests establishment of a PS session for voice services at 310 (e.g., sends, to the core network, a request for establishment of a PS session for voice services).

Based on a determination by the UE, that IMS voice over PS session is not available utilizing the candidate network associated with the access technology that is selected, the process continues at 312.

At 312, an identification of the network in association with an indication of the access technology for which IMS voice over PS session is not available, is stored in the information on the UE, identifying networks and associated access technologies for which IMS voice over PS session was not previously available or supported.

A timer is started at 314. The timer is associated with the identification of the network in association with the indication of the access technology stored in the information at the UE.

The process continues at 302 and further candidate network with associated access technology is identified, other than the networks with associated access technologies identified in the information stored.

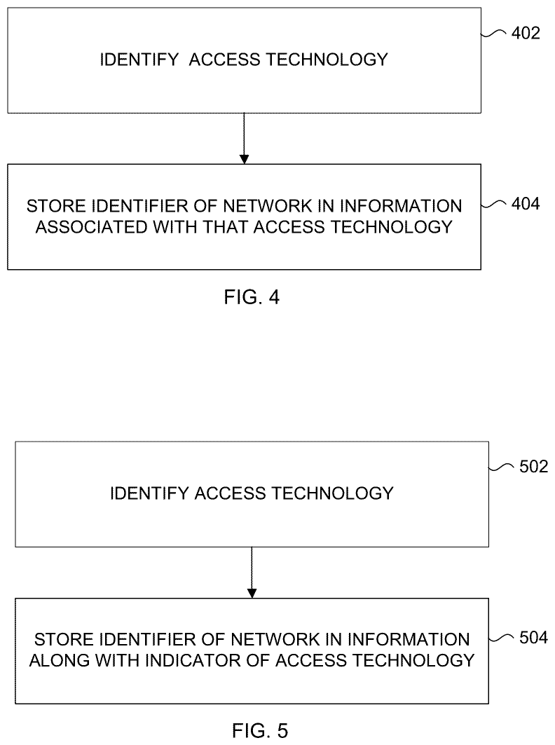

Continued reference is made to FIG. 3 with reference now to FIG. 4, which is a flow chart illustrating an example of processes of storing the identification of the network in association with the indication of access technology in the information at 312 in the method of FIG. 3.

In the example of FIG. 4, the UE at 402 identifies the access technology, i.e., terrestrial RAN or NTN RAN, and for which the determination is made that voice service is not available for the network in association with the access technology.

The identification of the network is then stored in association with that access technology at 404. For example, a network identification may be stored in a list or table that is associated with that access technology. Thus, the UE is configured to maintain two sets of information, including one set associated with terrestrial RAN and a second set associated with NTN RAN.

When the method proceeds at 302, a further candidate network with associated access technology identified is a candidate network other than the networks with associated access technologies identified in the two sets of information stored.

In the example in which a network identifier is stored in information associated with, one of terrestrial RAN and NTN RAN, the UE may select the same network associated with the other one of terrestrial RAN and NTN RAN as a candidate network at 302.

The UE sends a request to the network at 304 and a response is received at 306.

Based on a determination by the UE at 308, that the voice service is not available utilizing the candidate network with the other one of terrestrial RAN and NTN RAN, the UE identifies the access technology, i.e., the other one of terrestrial RAN and NTN RAN and stores the identification of the network in the information that is associated with that access technology at 404.

Reference is now made to FIG. 5 with continued reference to FIG. 3. FIG. 5 is a flow chart illustrating another example of processes of storing the identification of the network in association with the indication of access technology in the information at 312 in the method of FIG. 3.

In the example of FIG. 5, the UE at 502 identifies the access technology, i.e., terrestrial RAN or NTN RAN, and for which the determination is made that voice service is not available for the network in association with the access technology.

The identification of the network with an indicator of that access technology is stored in the information at 504. In this example, a single set of information, which may be a list or a table, for example, is stored, including identifications of networks along with indicators of access technologies.

In the example of FIG. 5, the method proceeds at 302 (after 314), and the further candidate network with associated access technology identified is a candidate network other than the networks with associated access technologies identified in the information stored.

In the example in which a network identifier with an indication of one of terrestrial RAN and NTN RAN is stored in the information, the UE may select the same network associated with the other one of terrestrial RAN and NTN RAN as a candidate network at 302.

The UE sends a request to the network at 304 and a response is received at 306.

Based on a determination by the UE at 308, that the voice service is not available utilizing the candidate network with the other one of terrestrial RAN and NTN RAN, the UE identifies the access technology, i.e., the other one of terrestrial RAN and NTN RAN, and stores the identifier of the network with an indicator of the other one of the terrestrial RAN and NTN RAN in the stored information on the UE. In this example, two entries are included in the information to identify the network associated with terrestrial RAN and to identify the same network associated with NTN RAN.

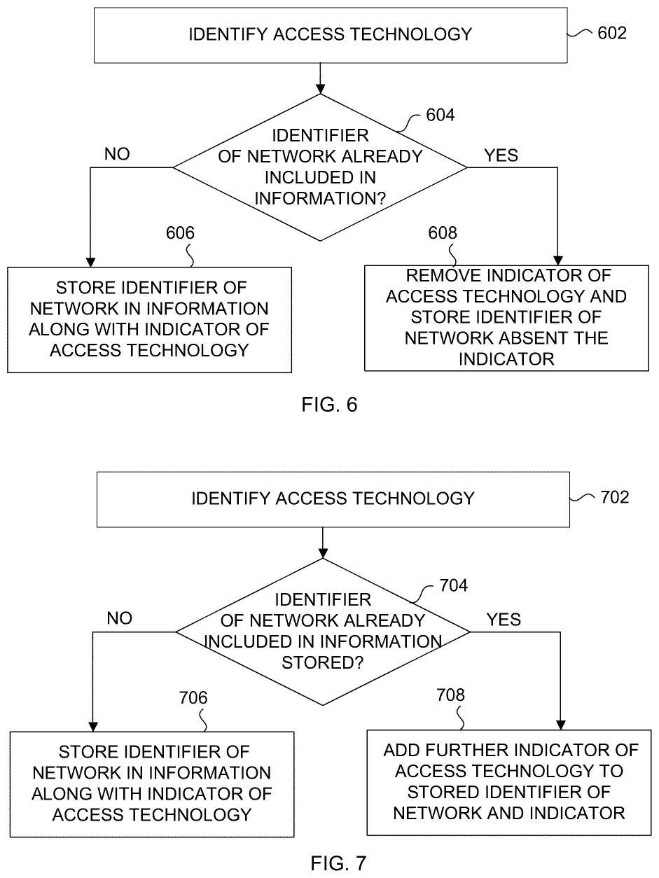

Reference is now made to FIG. 6 with continued reference to FIG. 3. FIG. 6 is a flow chart illustrating yet another example of processes of storing the identification of the network in association with the indication of access technology in the information at 312 in the method of FIG. 3.

In the example of FIG. 6, the UE at 602 identifies the access technology, i.e., terrestrial RAN or NTN RAN, and for which the UE determined that voice service is not available for the network in association with the access technology.

The UE determines at 604 if the network is already identified in the information. Based on a determination that the network identifier is not already included in the information at 604, the process continues at 606 and the network identifier in association with an indicator of the access technology, are stored in the information at 606.

Based on a determination that the network identifier is already included in the information at 604, the process continues at 608 and the indicator of the access technology stored in association with the network identifier, is removed such that the network identifier is stored absent an indicator of the access technology.

In the example of FIG. 6, the method proceeds at 302 (after 314).

In the example in which a network identifier with an indication of one of terrestrial RAN and NTN RAN is stored in the information, the UE may select the same network associated with the other one of terrestrial RAN and NTN RAN as a candidate network at 302.

The UE sends a request to the network at 304 and a response is received at 306.

Based on a determination by the UE at 308, that the voice service is not available utilizing the candidate network with the other one of terrestrial RAN and NTN RAN, the UE identifies the access technology at 602, i.e., the other one of terrestrial RAN and NTN RAN. Based on the determination that the network identifier is already included in the information at 604, the UE removes the indicator of access technology previously stored in association with the identifier of the network, at 608. Thus, the identifier of the network is stored in the information, absent any indicator. The network identifier absent the indicator of access technology, acts as an indicator of both terrestrial RAN and NTN RAN in association with the identifier of the network.

Reference is now made to FIG. 7 with continued reference to FIG. 3. FIG. 7 is a flow chart illustrating still another example of processes of storing the identification of the network in association with the indication of access technology in the information at 312 in the method of FIG. 3.

In the example of FIG. 7, the UE at 702 identifies the access technology, i.e., terrestrial RAN or NTN RAN, and for which the determination that voice service is not available for the network in association with the access technology.

The UE determines at 704 if the network is already identified in the information stored. Based on a determination that the network identifier is not already included in the information at 704, the process continues at 706 and the network identifier in association with an indicator of the access technology, are stored in the information at 706.

Based on the determination that that the network identifier is already included in the information at 704, the process continues at 708 and a further indicator of the access technology is stored in association with the network identifier. Thus, the network identifier is stored in association with an indicator of the terrestrial network and a second indicator of the NTN network.

In the example of FIG. 7, the method proceeds at 302 (after 314).

In the example in which a network identifier with an indication of one of terrestrial RAN and NTN RAN is stored in the information, the UE may select the same network associated with the other one of terrestrial RAN and NTN RAN as a candidate network at 302.

The UE sends a request to the network at 304 and a response is received at 306.

Based on a determination by the UE at 308, that the voice service is not available utilizing the candidate network with the other one of terrestrial RAN and NTN RAN, the UE identifies the access technology at 702, i.e., the other one of terrestrial RAN and NTN RAN. Based on the determination that the network identifier in association with an indicator of the access technology (i.e., the one of the terrestrial RAN and the NTN RAN), is already included in the information at 704, the UE adds a further identifier of the other one of the terrestrial RAN and NTN RAN in association with the identifier of the network, at 708.

Thus, the identifier of the network is stored in the information, with two indicators of access technology, including one indicator of terrestrial RAN and one indicator of NTN RAN.

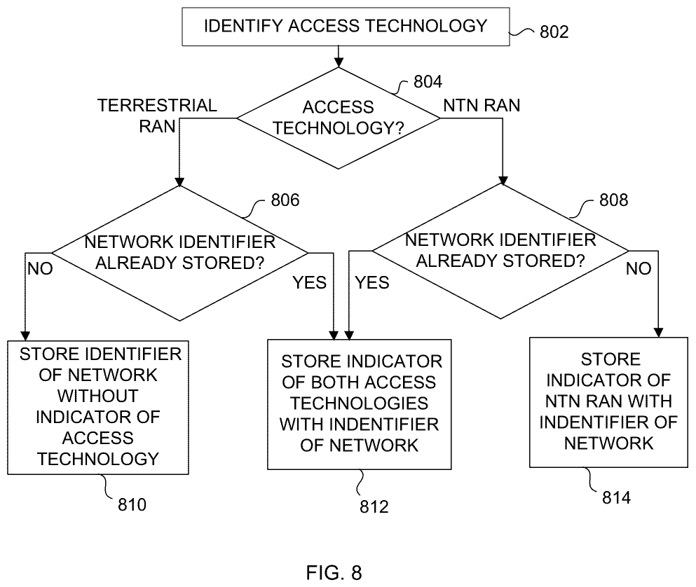

Reference is now made to FIG. 8 with continued reference to FIG. 3. FIG. 8 is a flow chart illustrating a further example of processes of storing the identification of the network in association with the indication of access technology in the information at 312 in the method of FIG. 3.

In the example of FIG. 8, the UE at 802 identifies the access technology, i.e., terrestrial RAN or NTN RAN, and for which the determination that voice service is not available for the network in association with the access technology.

The UE determines at 804 if the access technology is a terrestrial RAN or a NTN RAN.

If the access technology is determined to be terrestrial RAN at 804, the process continues at 806 where the UE determines if the network is already identified in the information stored. Based on the determination that the network identifier is not already included in the information at 806, the process continues at 810 and the network identifier is stored in the information absent any indicator of access technology. Thus, the lack of an indicator of the access technology serves as the indication that the access technology is terrestrial RAN.

Based on the determination that the network identifier is already included in the information at 806, the process continues at 812 and an indicator of both the terrestrial RAN and NTN RAN are stored in association with the network identifier stored in the information. The indicator of both access technologies may be any suitable indicator stored in association with the network identifier. Thus, the network identifier is stored in association with an indicator of both the terrestrial network the NTN network.

If the access technology is determined to be NTN RAN at 804, the process continues at 808 where the UE determines if the network is already identified in the information stored. Based on the determination that the network identifier is not already included in the information at 808, the process continues at 814 and the network identifier along with an indicator of the NTN RAN is stored in the information.

Based on the determination that the network identifier is already included in the information at 808, the process continues at 812 where the indicator of both the terrestrial RAN and NTN RAN is stored in association with the network identifier stored in the information.

Advantageously, the UE stores an identifier of a network in association with an access technology comprising one of terrestrial radio access network (RAN) and satellite-based RAN after determining that voice service over a packet switching (PS) session is not available (e.g., IMS voice over PS session is not available). Voice service over PS session may be available, however, for the same network with a different access technology. The inclusion of the indicator of the access technology with the network identifier in the information facilitates the selection of a network, for example, via a satellite-based RAN even in instances in which voice service is not available for the same network via a terrestrial RAN. Similarly, the inclusion of the indicator of the access technology with the network identifier in the information facilitates the selection of a network, for example, via terrestrial RAN even in instances in which voice service is not available for the same network via a satellite-based RAN. Thus, repetition, by the UE, of attempts to register with a network via an access technology for which voice service is unavailable is reduced, without inhibiting the UE from attempting to register with a network via the other access technology, for which voice service may be available.

Embodiments including functions, processes, and operations, may be implemented in software, hardware, application logic or a combination of software, hardware and application logic. The software, application logic and/or hardware may reside on memory. In the context of this application, a “memory” or “computer-readable medium” may be any non-transitory media or that includes or stores, communicates, or transports the instructions for execution by one or more processors.

The functions, processes, and operations described herein may be performed in a different order, or may be performed concurrently with each other, or a combination thereof. Furthermore, one or more of the functions, processes, and operations may be optional or may be combined. Various operations and processes shown in the flow charts are optional or are alternatives and may be omitted, may be reordered, may be combined, or a combination of reordered and combined.

The scope of the claims should not be limited by the preferred embodiments set forth in the examples but should be given the broadest interpretation consistent with the description as a whole.

1. A user equipment comprising:
at least one processor; and
at least one memory storing instructions which, when executed by the at least one processor, cause the user equipment to perform:
sending a request to register the user equipment with a network associated with an access technology comprising one of terrestrial radio access network (RAN) and satellite-based RAN, the UE having a usage setting set to voice centric;
receiving a response to the request, the response comprising information indicating that a voice service not available;
based on the response comprising information indicating that a voice service of the network is not available, storing an identification of the network in association with an indication of the access technology associated with the network for which voice service of the network is not available, in information identifying networks with associated access technologies for which the voice service is not available; and
selecting, a candidate network for sending a further request to register the user equipment, the candidate network with associated access technology other than the networks with associated access technologies identified in the information stored.

2. The user equipment of claim 1, wherein selecting comprises excluding selection of the networks with the associated access technologies identified in the information stored unless no other network and associated access technology is available that is not identified in the information.

3. The user equipment of claim 1, wherein storing the identification of the network in association with the indication of the access technology associated with the network for which the voice service is not available comprises storing, in information associated with the access technology, the identification of the network.

4. The user equipment of claim 3, wherein the instructions, when executed by the at least one processor, further cause the user equipment to perform:
sending a further request to register the UE with the network associated with an other access technology comprising an other one of the terrestrial RAN and satellite-based RAN;
receiving a further response to the request and, based on the further response, determining that the voice service is not available for the other access technology associated with the network.

5. The user equipment of claim 4, wherein the instructions, when executed by the at least one processor, further cause the user equipment to perform:
storing, in second information associated with the other access technology, the identification of the network;
selecting, as another candidate network for sending another request to, another network and associated access technology other than the networks with associated access technologies identified in any of the information stored and the second information stored.

6. The user equipment of claim 4, wherein the instructions, when executed by the at least one processor, further cause the user equipment to perform:
storing, in association with the identification of the network stored in the information, an indicator associated with both the access technology and the other access technology.

7. The user equipment of claim 1, wherein storing the identification of the network in association with the indication of the access technology associated with the network for which voice service of the network is not available, comprises storing, in the information, the identification of the network along with an indicator of the access technology.

8. The user equipment of claim 7, wherein the instructions, when executed by the at least one processor, further cause the user equipment to perform:
sending a further request to the network associated with another access technology comprising an other one of the terrestrial RAN and satellite-based RAN;
receiving a further response to the further request; and
based on the response, determining that the voice service is not available for the other access technology associated with the network.

9. The user equipment of claim 8, wherein the instructions, when executed by the at least one processor, further cause the user equipment to perform:
storing, in the information, another indicator of the other access technology in association with the identification of the network in the information.

10. The user equipment of claim 8, comprising storing a further entry in the information, the further entry including the identification of the network along with a further indicator of the other access technology associated with the network.

11. The user equipment of claim 8, comprising removing the indicator of the access technology associated with the network for which voice service of the network is not available such that the identification of the network is stored absent the indicator in the information.

12. The user equipment of claim 11, wherein the network for which the identification is stored absent the indicator in the information, is excluded from selection as an other candidate network for sending an other request to unless no alternative network or alternative network and associated access technology that is not identified in the information stored, is available.

13. The user equipment of claim 8, comprising changing the indicator of the access technology stored in association with the identification of the network in the information, to a second indicator of both the access technology and the other access technology.

14. The user equipment of claim 1, comprising starting a timer associated with the identification of the network in association with the indication of the access technology associated with the network for which voice service is not available, after receiving the response.

15. The user equipment of claim 1, wherein receiving the response to the request comprises receiving a registration accept, indicating that voice service is not available.

16. A method performed by a user equipment, the method comprising:
sending a request to register the user equipment with a network associated with an access technology comprising one of terrestrial radio access network (RAN) and satellite-based RAN, the UE having a usage setting set to voice centric;
receiving a response to the request, the response comprising information indicating that a voice service not available;
based on the response comprising information indicating that a voice service of the network is not available, storing an identification of the network in association with an indication of the access technology associated with the network for which voice service of the network is not available, in information identifying networks with associated access technologies for which the voice service is not available; and
selecting, a candidate network for sending a further request to register the user equipment, the candidate network with associated access technology other than the networks with associated access technologies identified in the information stored.

17. A non-transitory computer-readable medium comprising instructions which, when executed by at least one processor of a user equipment, cause the user equipment to perform:
sending a request to register the user equipment with a network associated with an access technology comprising one of terrestrial radio access network (RAN) and satellite-based RAN, the UE having a usage setting set to voice centric;
receiving a response to the request, the response comprising information indicating that a voice service not available;
based on the response comprising information indicating that a voice service of the network is not available, storing an identification of the network in association with an indication of the access technology associated with the network for which voice service of the network is not available, in information identifying networks with associated access technologies for which the voice service is not available; and
selecting, a candidate network for sending a further request to register the user equipment, the candidate network with associated access technology other than the networks with associated access technologies identified in the information stored.
